(19) United States
(12) Patent Application Publication
(10) Pub. No.: US 2010/0014892 A1
(43) Pub. Date: Jan. 21, 2010

(54) OPTICAL SCANNING APPARATUS AND IMAGE FORMING APPARATUS USING SAME

(75) Inventor: Hidekazu Shimomura, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/502,817

(22) Filed: Jul. 14, 2009

(30) Foreign Application Priority Data
Jul. 16, 2008 (JP) 2008-184755

(51) Int. Cl. G03G 15/04; G02B 26/10

(52) U.S. Cl. 399/221; 359/204.1

(57) ABSTRACT

There are provided a compact light scanning apparatus including a deflection unit for deflectively scanning light fluxes, and an imaging optical systems provided for the respective light fluxes. When the light fluxes deflectively scanned by the deflection unit are focused onto different photosensitive drums by the imaging optical systems, through a mirror. One of the imaging optical systems includes a transmission type imaging optical element. In a sub-scanning section, the principal ray of a light flux passing through the transmission type imaging optical element passes a side opposite to the optical path of the light flux deflectively scanned by the deflection unit and traveling toward the mirror of another imaging optical system among the imaging optical systems with respect to a straight line connecting the surface vertex of the incidence surface of the transmission type imaging optical element and the surface vertex of the emergence surface thereof.

### BACKGROUND OF THE INVENTION

1. Field of the Invention

The present invention relates to a optical scanning apparatus and an image forming apparatus using the same. The present invention is suitably applied to image forming apparatuses such as laser beam printers (LBP), digital copying machines, and multi-function printers that use an electrophotographic process.

2. Description of the Related Art

A optical scanning apparatus has been conventionally used in a laser beam printer (LBP), a digital copying machine, a multi-function printer, and the like.

In the optical scanning apparatus, a light flux (or a light beam) having been optically modulated according to an image signal and emitted from light source unit is periodically deflected by a optical deflector in the form of, for example, a rotary multi-face mirror (or polygon mirror). The light flux thus deflected is converged by an imaging optical system having an fθ characteristic onto a surface of a photosensitive recording medium (or photosensitive drum) as a spot. The surface is scanned by the light, whereby an image is recorded thereon.

FIG. 17 is a schematic diagram showing the relevant portions of a conventional optical scanning apparatus.

In FIG. 17, one or plurality of divergent light fluxes emitted from light source unit 1 are converted into parallel light fluxes by a collimator lens 2. The light fluxes are restricted by a stop 3, and then incident on a cylindrical lens 4 that has a specific refracting power only in a sub-scanning direction. The parallel light fluxes incident on the cylindrical lens 4 emerge from it without being changed in the main scanning section. The light fluxes are converged in the sub-scanning section, so that it forms a line image on a deflection surface (or reflecting surface) 5a of a optical deflector 5 in the form of a polygon mirror.

The light fluxes deflected by the deflection surface 5a of the optical deflector 5 is guided onto the surface of the photosensitive drum 8 or the scanned surface by an imaging lens 6 having an fθ characteristic. With the rotation of the optical deflector 5 in the direction indicated by arrow A, the surface of the photosensitive drum 8 is scanned with one or plurality of light fluxes in the direction indicated by arrow B (i.e. the main scanning direction), whereby image information is recorded thereon. The apparatus shown in FIG. 17 is also provided with a mirror 18 for detecting synchronization and sensor 19 for detecting synchronization.

FIGS. 18 and 19 schematically show the relevant portions of color image forming apparatuses.

The color image forming apparatuses shown in FIGS. 18 and 19 are each provided with a optical scanning apparatus in which an optical deflector (or rotary multi-face mirror) is commonly used to deflect a plurality of beams in order to make the entire apparatus compact.

In the optical scanning apparatus shown in FIG. 18, scanned surfaces 8A and 8B are scanned by two light fluxes Ra and Rb respectively on two opposite sides of the optical deflector 5. In FIG. 18, two light fluxes or upper and lower light fluxes Ra, Rb are made incident on one deflection surface of the optical deflector 5 from oblique directions in the sub-scanning section. On one side of the optical deflector 5 (i.e. on the scanning unit SR side), the two scanned surfaces 8A and 8B are scanned by corresponding imaging optical systems SA and SB respectively.

The imaging optical system SB includes an optical path folding mirrors M2 to M4 and imaging lenses 6A and 7B. The imaging optical system SA includes an optical path folding mirror M1 and imaging lenses 6A and 7A.

On the other side (i.e. on the scanning unit SL side) also, two scanned surfaces 8C and 8D are scanned with corresponding light fluxes in a similar manner by imaging optical systems. In FIG. 18, a motor 9 is also illustrated.

In the optical scanning apparatus shown in FIG. 19, which is a partial modification of that shown in FIG. 18, scanning is performed by two light fluxes R1a, R1b on one side of the optical deflector 5.

In FIG. 19, one imaging optical system SA includes an optical path folding mirror M11 and imaging lenses 61A, 71A and guides the light flux R1a to a photosensitive drum 81A. The other imaging optical system SB includes optical path folding mirrors M12, M13 and imaging lenses 61A, 71B and guides the light flux R1b to a photosensitive drum 81B.

Two optical scanning apparatuses of the above-described type may be arranged side by side in such a way as to be opposed to the optical deflector 5, whereby four scanned surfaces can be scanned. In FIG. 19, a protection glass CG and a motor 9 are also illustrated.

Various optical scanning apparatuses that scan different positions on the same drum with a plurality of light fluxes have been developed (see Japanese Patent Application Laid-Open No. H10-3052).

FIG. 20 schematically shows the relevant portions of the optical scanning apparatus disclosed in Japanese Patent Application Laid-Open No. H10-3052 as embodiment 5.

The apparatus shown in FIG. 20 has light source unit 217 and 218. In the apparatus shown in FIG. 20, an imaging lens 210 located closest to an optical deflector (deflecting unit) 205 is used commonly for two light fluxes that have been deflectively scanned by the optical deflector 205. In addition, two imaging lenses 201 and 202 closest to a scanned surface 215 are separately provided for the respective light fluxes. These imaging lenses 201 and 202 are arranged one above the other along the vertical direction. The optical paths of the light fluxes having passed through the two imaging lenses 201, 202 are separated and folded by the corresponding mirrors 211, 212, 213, and 214 and then scan respective corresponding imaging positions 215a and 215b.

Optical scanning apparatuses for color image forming apparatus that have been developed heretofore have disadvantages as described below.

In the case of the conventional optical scanning apparatus shown in FIG. 18, the principal ray Rbo of the light flux Rb deflectively scanned by the optical deflector 5 and traveling toward the photosensitive drum 8B does not pass through the center CL of the outer shape of the imaging lens 7B in the sub-scanning section, and the dimension of the imaging lens 7B in the sub-scanning direction is larger than necessary. Arranging the optical components in such a way as to prevent interference of the light flux Ra traveling toward the optical path folding mirror M1 with the unnecessarily large imaging lens 7B makes the size of the cabinet 10 of the optical scanning apparatus itself large, which in turn makes the size of the image forming apparatus large.

In the case of the conventional optical scanning apparatus shown in FIG. 19, interference of the light flux R1b deflectively scanned by the optical deflector 5 and traveling toward the optical path folding mirror M12 with the imaging lens 71B occurs. This may be prevented by disposing the imaging lens 71B closer to the scanned surface (namely, in the vicinity of the dust glass CG) than the optical path folding mirror M13 that is optically closest to the scanned surface 81B in the imaging optical system SB. However, a positional shift of the imaging lens 71B toward the scanned surface 81B leads to an increase in the dimension of the lens with respect to the main scanning direction, which makes the size reduction difficult.

Here, in the context of this specification, the term “optically” unit “in a state in which the optical path is developed”.

On the other hand, in the optical scanning apparatus disclosed in Japanese Patent Application Laid-Open No. H10-3052 and shown in FIG. 20, the imaging lenses 201, 202 having an asymmetric shape with respect to the center CL of the outer shape of the lens are arranged one above the other in the sub-scanning section shown in FIG. 21. In this optical scanning apparatus disclosed in Japanese Patent Application Laid-Open No. H10-3052, the light fluxes are separated and folded by the mirrors after they have passed all the imaging lenses. Therefore, the problem of interference of the imaging lenses and the light fluxes is not encountered with this optical scanning apparatus.

However, in the apparatus disclosed in Japanese Patent Application Laid-Open No. H10-3052, the reference 219 of mounting (or reference of positioning) of the imaging lenses 201, 202 arranged one above the other with respect to the sub-scanning direction is displaced along the main scanning direction as shown in FIG. 22.

Arranging the two imaging lenses 201, 202 one above the other in this way requires to provide a reference of positioning, which undesirably makes the structure of the apparatus complex.

### SUMMARY OF THE INVENTION

According to the present invention, a plurality of light fluxes are deflectively scanned by one deflection surface, and the shape of an imaging lens that guides the light fluxes to respective scanned surfaces is appropriately designed. It is an object of the present invention to increase the degree of freedom in the arrangement of optical components by the above feature and provide a optical scanning apparatus and an image forming apparatus equipped with the same which can be made small in the overall size and in which a plurality of scanned surfaces can be scanned without interference of the imaging lens and light fluxes and with reduced vignetting of light fluxes.

It is another object of the present invention to reduce the cross sectional area of a lens by eliminating a useless area through which no scanning light flux passes, thereby increasing the number of lenses manufactured by one metal mold to reduce the cost.

To achieve the above object, a optical scanning apparatus according a first aspect of the present invention comprises a plurality of light source unit, deflection unit for deflectively scanning a plurality of light fluxes emitted from the plurality of light source unit by a same deflection surface, and a plurality of imaging optical systems respectively associated with the plurality of light fluxes deflectively scanned by the same deflection surface of the deflection unit, the plurality of light fluxes having been deflectively scanned by the same deflection surface of the deflection unit being respectively focused on different photosensitive drums by the plurality of imaging optical systems associated with the plurality of light fluxes, wherein in a sub-scanning section, each of the plurality of light fluxes incident on the same deflection surface of the deflection unit is incident on the deflection surface from an oblique direction, each of the plurality of imaging optical system includes a mirror, one imaging optical system among the plurality of imaging optical systems includes a transmission type imaging optical element provided in an optical path between the mirror and the photosensitive drum, and in the sub-scanning section, at least one of a surface vertex or virtual surface vertex of an incidence surface of the transmission type imaging optical element and a surface vertex or virtual surface vertex of an emergence surface of the transmission type imaging optical element is decentered from a center CL of an outer shape of the transmission type imaging optical element to a side same as an optical path on which a light flux Ra having been deflected by the deflection surface and traveling toward a mirror in another imaging optical system among the plurality of imaging optical systems.

In the above-described optical scanning apparatus, it is preferred that in the sub-scanning section, a principal ray Rbo of a light flux Rb passing through the transmission type imaging optical element pass through a side opposite to the optical path on which the light flux having been deflected by the deflection surface and traveling toward the mirror of the other imaging optical system among the plurality of imaging optical systems, with respect to a straight line PL connecting the surface vertex or virtual surface vertex of the incidence surface of the transmission type imaging optical element and the surface vertex or virtual surface vertex of the emergence surface of the transmission type imaging optical element.

A optical scanning apparatus according to a second aspect of the present invention comprises light source unit, deflection unit for deflectively scanning a light flux emitted from the light source unit by a deflection surface, and an imaging optical system that focuses the light flux having been deflectively scanned by the deflection surface of the deflection unit on a photosensitive drum, wherein in a sub-scanning section, the light flux incident on the deflection surface of the deflection unit is incident on the deflection surface from an oblique direction, the imaging optical system includes a mirror, the imaging optical system includes a transmission type imaging optical element provided in an optical path between the mirror and the photosensitive drum, and in the sub-scanning section, at least one of a surface vertex or virtual surface vertex of an incidence surface of the transmission type imaging optical element and a surface vertex or virtual surface vertex of an emergence surface of the transmission type imaging optical element is decentered from a center of an outer shape of the transmission type imaging optical element to a side same as an optical path on which a light flux having been deflected by the deflection surface and traveling toward the mirror.

In this optical scanning apparatus, it is preferred that in the sub-scanning section, a principal ray of a light flux Rb1 passing through the transmission type imaging optical element pass through a side opposite to the optical path on which the light flux having been deflected by the deflection surface and traveling toward the mirror, with respect to a straight line connecting the surface vertex or virtual surface vertex of the incidence surface of the transmission type imaging optical element and the surface vertex or virtual surface vertex of the emergence surface of the transmission type imaging optical element.

A optical scanning apparatus according to a third aspect of the present invention comprises light source unit, deflection unit for deflectively scanning a light flux emitted from the light source unit by a deflection surface, and an imaging optical system that focuses the light flux having been deflectively scanned by the deflection surface of the deflection unit on a photosensitive drum, wherein in a sub-scanning section, the light flux incident on the deflection surface of the deflection unit is incident on the deflection surface from an oblique direction, the imaging optical system includes a mirror, the imaging optical system includes a transmission type imaging optical element provided in an optical path between the mirror and the photosensitive drum, and in the sub-scanning section, the transmission type imaging optical element lacks an element portion on a side opposite to a side on which a light flux having been deflected by the mirror is incident, with respect to a straight line connecting a surface vertex or a virtual surface vertex of an incidence surface of the transmission type imaging optical element and a surface vertex or a virtual surface vertex of an emergence surface of the transmission type imaging optical element under the hypothetical assumption that the transmission type imaging optical system had a symmetrical shape, and has an asymmetrical shape with respect to a center of an outer shape of the transmission type imaging optical system.

An image forming apparatus according to another aspect of the present invention comprises the optical scanning apparatus according to the first aspect, the plurality of photosensitive members, a plurality of developing devices that are provided in association with the plurality of photosensitive members and develop electrostatic latent images formed on the respective photosensitive members by the light fluxes scanned by the optical scanning apparatus into toner images, a plurality of transferring devices that are provided in association with the plurality of photosensitive members and transfer the developed toner images onto a transferred material, and a plurality of fixing devices that are provided in association with the plurality of photosensitive members and fix the transferred toner images on the transferred material.

An image forming apparatus according to another mode comprises the optical scanning apparatus according to the second aspect, the photosensitive member, a developing device that develops an electrostatic latent image formed on the photosensitive member by the light flux scanned by the optical scanning apparatus into a toner image, a transferring device that transfers the developed toner image onto a transferred material, and a fixing device that fixes the transferred toner image on the transferred material.

An image forming apparatus according to still another mode comprises the optical scanning apparatus according to the third aspect, the photosensitive member, a developing device that develops an electrostatic latent image formed on the photosensitive member by the light flux scanned by the optical scanning apparatus into a toner image, a transferring device that transfers the developed toner image onto a transferred material, and a fixing device that fixes the transferred toner image on the transferred material.

Further features of the present invention will become apparent from the following description of exemplary embodiments with reference to the attached drawings.

### BRIEF DESCRIPTION OF THE DRAWINGS

FIG. 1 is a cross sectional view of a optical scanning apparatus according to a first embodiment of the present invention taken on the sub-scanning section.

FIG. 2 is a cross sectional view of a optical scanning apparatus according to the first embodiment of the present invention taken on the main scanning section.

FIG. 3 is cross sectional view taken on the sub scanning section showing a lens 7A used in the first embodiment of the present invention.

FIG. 4 is an enlarged view taken on the sub-scanning section, showing the optical scanning apparatus according to the first embodiment of the present invention.

FIG. 5 is a cross sectional view taken on the sub-scanning section showing the incidence optical system of the optical scanning apparatus according to the first embodiment of the present invention.

FIG. 6 is a graph showing the curvature of field in the first embodiment of the present invention.

FIG. 7 is a graph showing displacement of the imaging position in the main scanning direction in the first embodiment of the present invention.

FIG. 8 is a graph showing the scanning line bending in the first embodiment of the present invention.

FIG. 9 is a graph showing the jitter in the main scanning direction in the first embodiment of the present invention.

FIG. 10 shows spot profiles in the first embodiment of the present invention.

FIGS. 11A, 11B, 11C and 11D illustrate the positions on the lenses through which light fluxes pass in the first embodiment of the present invention.

FIG. 12 is a cross sectional view of a optical scanning apparatus according to a second embodiment of the present invention taken on the sub-scanning section.

FIG. 13 shows the shape of a lens according to a third embodiment of the present invention.

FIG. 14 shows an arrangement of lens molds in the third embodiment of the present invention.

FIG. 15 shows a conventional mold arrangement.

FIG. 16 is a schematic view showing the relevant portions of a color image forming apparatus according to an embodiment of the present invention.

FIG. 17 is perspective view showing the relevant portions of a conventional optical scanning apparatus.

FIG. 18 is a cross sectional view of a conventional optical scanning apparatus taken on the sub-scanning section.

FIG. 19 is a cross sectional view of a conventional optical scanning apparatus taken on the sub-scanning section.

FIG. 20 is a perspective view showing the relevant portions of a conventional optical scanning apparatus.

FIG. 21 is a cross sectional view of lenses used in a conventional optical scanning apparatus.

FIG. 22 is a cross sectional view of the lenses used in the conventional optical scanning apparatus.

FIGS. 23A, 23B, 23C and 23D show various types of lenses according to the present invention.

FIG. 24 is a schematic view of a fourth embodiment of the present invention.

### DESCRIPTION OF THE EMBODIMENTS

A optical scanning apparatus according to an embodiment has a plurality of light source unit, deflecting unit for deflectively scanning the plurality of light fluxes emitted from the plurality of light source unit by the same deflection surface, and a plurality of imaging optical systems provided respectively for the plurality of light fluxes deflectively scanned by the same deflection surface of the deflecting unit.

The plurality of light fluxes deflectively scanned by the same deflection surface of the deflecting unit are guided by the corresponding plurality of imaging optical systems onto different photosensitive drums respectively.

In the sub-scanning section, each of the plurality of light fluxes incident on the same deflection surface of the deflecting unit is incident on the deflection surface from an oblique direction.

Each of the plurality of imaging optical systems is provided with an optical path folding mirror(s).

One imaging optical system SB among the plurality of imaging optical systems includes a transmission type imaging optical element 7B provided in the optical path between an optical path folding mirror M3 and a photosensitive drum 8B. (Reference signs appearing here and below refer to elements in the embodiments that will be described later.)

In the sub-scanning section, at least one of the surface vertex (or virtual surface vertex) of the incidence surface of the transmission type imaging optical element 7B and the surface vertex (or virtual surface vertex) of the emergence surface of the transmission type imaging optical element 7B is arranged as follows.

At least one of the aforementioned surface vertices is decentered from the center CL of the outer shape of the transmission type imaging optical element 7B toward the same side as the optical path of the light flux Ra deflected by the deflection surface and travelling toward the optical path folding mirror M1 of the other imaging optical system among the plurality of imaging optical systems.

Here, the surface vertex refers to the point of intersection of the lens surface and the optical axis. The virtual surface vertex refers to an imaginary surface vertex of an optical element that has a partly cut-away shape and lacks the portion corresponding to the optical axis.

Furthermore, in the sub-scanning section, the principal ray Rbo of the light flux Rb that passes through the transmission type imaging optical element 7B is arranged in the following manner relative to the straight line PL connecting the surface vertex (or virtual surface vertex) of the incidence surface of the transmission type imaging optical element 7B and the surface vertex (or virtual surface vertex) of the emergence surface of the transmission type imaging optical element.

The aforementioned principal ray Rbo passes on the opposite side, with respect to the aforementioned straight line PL, of the optical path of the light flux deflected by the deflection surface and traveling toward the optical path folding mirror M1 of the other imaging optical system SA among the plurality of imaging optical systems.

Furthermore, it is assumed that the transmission type imaging optical element 7B has a symmetrical shape in the sub-scanning section. Under this assumption, the straight line connecting the surface vertex of the incidence surface of the transmission type imaging optical element 7B and the surface vertex of the emergence surface of the transmission type imaging optical element 7B will be denoted by PL. Then, a portion of the transmission type imaging optical element on the side, with respect to the straight line PL, opposite to the side on which the light flux folded by the optical path deflecting mirror M3 is incident is cut away, and the transmission type imaging optical element 7B has an asymmetrical shape with respect to the center CL of the outer shape of it. In the following, embodiments of the present invention will be described with reference to the drawings.

### First Embodiment

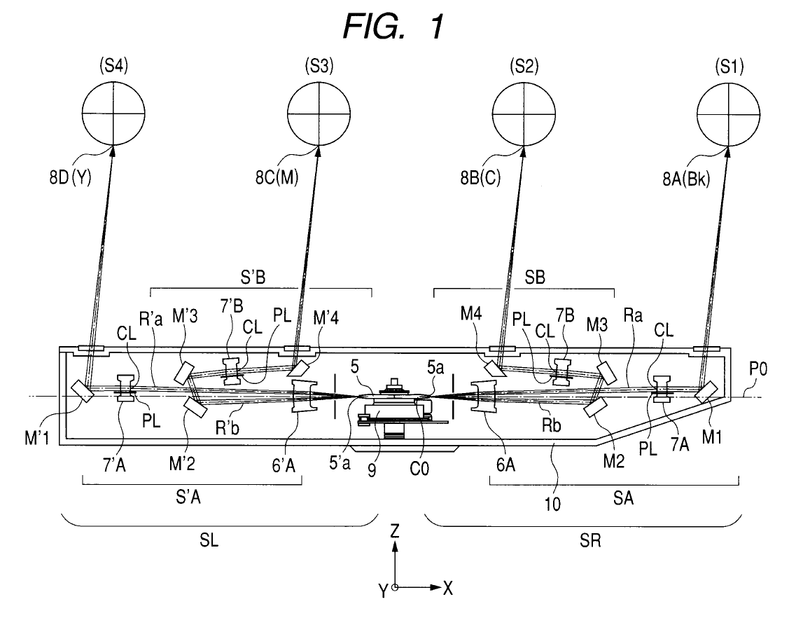

FIG. 1 is a cross sectional view taken along the sub-scanning direction (sub-scanning section), showing the relevant portions of a optical scanning apparatus according to a first embodiment of the present invention.

In the following description, the term “axis” in the expressions “optical axis” and “on axis” used in connection with the imaging optical system (or scanning optical system) will refer to the axis that is perpendicular to the scanned surface at the center of the scanned surface. The term “optical axis of a lens” refers to the straight line connecting the surface vertices (curvature centers) of the incidence surface and the emergence surface of the lens.

The main scanning direction (Y direction) refers to the direction along which light fluxes are deflectively scanned by an optical deflector (or rotary multi-face mirror) serving as the deflecting unit. The sub-scanning direction (Z direction) refers to the direction parallel to the rotation axis of the optical deflector. The main scanning section is a plane having a normal that is parallel to the rotation axis of the deflecting unit. The sub-scanning section refers to a plane having a normal that is parallel to the axis along the main scanning direction.

The optical scanning apparatus according to this embodiment is provided with two scanning units SR, SL arranged with an optical deflector 5 between to deflectively scan four light fluxes Ra, Rb, Ra′, Rb′ by the single optical deflector 5, thereby scanning respective corresponding photosensitive drum surfaces 8A (Bk), 8B (C), 8C(M), 8D (Y).

In the scanning unit SR, the deflected light flux Ra having been deflectively reflected by the deflection surface 5a of the optical deflector (i.e. five-surface polygon mirror) 5 is transmitted through the imaging lenses 6A, 7A and then diverted by the optical path folding mirror M1. The light flux Ra thus diverted by the optical path folding mirror M1 is guided to the scanned surface or the photosensitive drum 8A (Bk). (This system will be hereinafter referred to as the “station S1”.)

The deflected light flux Rb having been deflectively reflected by the deflection surface 5a of the optical deflector 5 is transmitted through the imaging lens 6A, and then diverted by the optical path folding mirrors M2, M3. The light flux Rb thus diverted is transmitted through the transmission type imaging optical element or the imaging lens 7B, then diverted by the optical path folding mirror M4, and then guided to the scanned surface or the photosensitive drum 8B (C). (This system will be hereinafter referred to as the “station S2”.)

On the other hand, in the other scanning unit SL, the deflected light flux R′a having been deflectively reflected by the deflection surface 5′a of the optical deflector 5 is transmitted through the imaging lenses 6′A, 7′A and then diverted by the optical path folding mirror M′1. The light flux R′a thus diverted by the optical path folding mirror M′1 is guided to the scanned surface or the photosensitive drum 8D (Y). (This system will be hereinafter referred to as the “station S4”.)

The deflected light flux R′b having been deflectively reflected by the deflection surface 5′a of the optical deflector 5 is transmitted through the imaging lens 6′A, and then diverted by the optical path folding mirrors M′2, M′3. The light flux R′b thus diverted is transmitted through the transmission type imaging optical element or the imaging lens 7′B, and then diverted by the optical path folding mirror M′4. The light flux R′b thus diverted is guided to the scanned surface or the photosensitive drum 8C (M). (This system will be hereinafter referred to as the “station S3”.)

In the following description, the optical systems that form images on the scanned surfaces 8A, 8D that are farthest from the optical deflector 5 (namely, the optical systems that scan these scanned surfaces) will be designated as the imaging optical system SA and S′A. On the other hand, the optical systems that form images on the scanned surfaces 8B, 8C that are closest to the optical deflector 5 (i.e. optical systems for scanning scanned surfaces) will be designated as the imaging optical systems SB and S′B

Each of the plurality of imaging optical systems SA, SB (S′A, S′B) is composed of a plurality of imaging lenses, and the imaging lens 6A (6′A) closest to the optical deflector 5 is shared by the plurality of imaging optical systems SA, SB (S′A, S′B).

Here, the expression “closest to the optical deflector 5” means “physically closest to the deflection surface of the optical deflector 5 in the structure of the apparatus”, and the expression “farthest from the optical deflector 5” means “physically farthest from the deflection surface of the optical deflector 5 in the structure of the apparatus”.

The two scanning units SR and SL have the same configuration and the same optical effect, and therefore the following description will be mainly directed to the scanning unit SR. Components in the scanning unit SL the same as those in the scanning unit SR will be denoted by reference signs in parentheses, and components of the scanning unit SL will be described when needed.

In FIG. 1, the center axis of the outer shape (or outer shape center) CL of each of the imaging lens 7B (7′B) and the imaging lens 7A (7′A) with respect to the sub-scanning direction is indicated. The straight line PL connecting the surface vertex of the incidence surface and the surface vertex of the emergence surface of each of the imaging lens 7B (7′B) and the imaging lens 7A (7′A) is drawn in FIG. 1.

In this embodiment, the imaging optical lens 7B (7′B) is disposed optically closer to the optical deflector 5 than the optical path folding mirror M4 (M′4) optically closest to the scanned surface, whereby the length of the imaging lens 7B (7′B) along the main scanning direction is made short, and the overall size of the apparatus is made small.

As described before, interference of the scanning light flux Ra (R′a) and the imaging lens 7B (7′B) can be prevented by arranging the imaging lens 7B (7′B) optically closest to the scanned surface 8B (8C) in the imaging optical system SB (S′B) closer to the scanned surface than the optical path folding mirror M4 (M′4). However, this arrangement of the components necessitates an increase in the length of the imaging lens 7B (7′B) with respect to the main scanning direction, which leads to an increase in the overall size of the apparatus.

Furthermore, in this embodiment, the imaging lens 6A (6′A) closest to the optical deflector 5 is shared by the plurality of imaging optical systems SA, SB (S′A, S′B), whereby the number of imaging lenses is reduced and the overall apparatus is made compact.

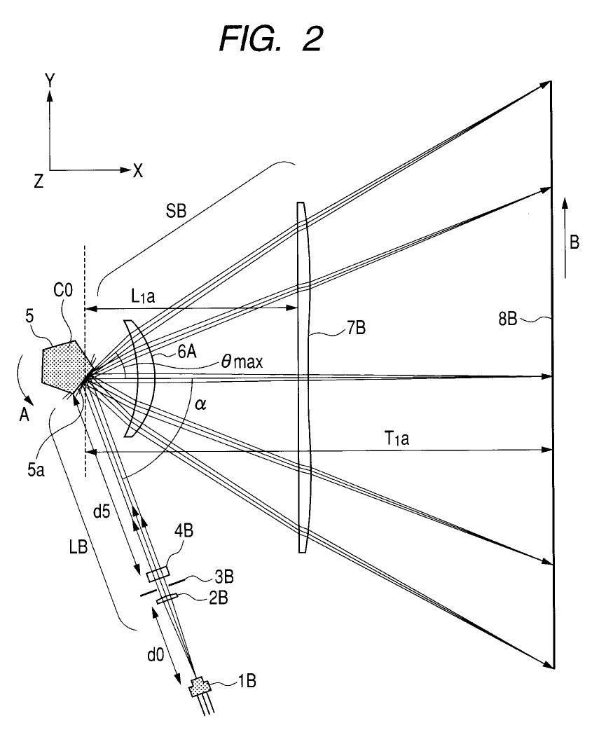

FIG. 2 is a cross sectional view taken on the main scanning section of the station S2 shown in FIG. 1. In FIG. 2, the optical path folding mirrors are not illustrated. The configuration and the optical effect of the other stations S1, S3, S4 are substantially the same as those of the station S2.

In FIG. 2, the principal ray (center line) of the on-axis light flux is deflected at a deflection point (reference point) C0. In the sub-scanning direction, the light flux Ra and the light flux Rb intersect at the deflection point C0. The deflection point C0 is the reference point of the imaging optical system. The distance from the deflection point C0 to the scanned surface will be hereinafter referred to as the “optical path length of the imaging optical system”.

In this embodiment, the optical path length T₁a=246 mm. The ratio K (or Kθ coefficient: Y=Kθ) of the scanning image height Y (mm) to the scanning angle θ (rad) and the degree of convergence m of the light flux incident on the optical deflector 5 with respect to the main scanning direction are as follows:

K=210.0 (mm/rad),

m=1−Sk/f,

where Sk is the distance from the posterior principal plane of the imaging optical system to the scanned surface in the main scanning section in millimeter (mm), and f is the focal length of the imaging optical system in the main scanning section in millimeter (mm).

The degree of convergence m provides distinction between the following three cases depending on its value:
when m=0, the light flux incident on the optical deflector is a parallel light flux in the main scanning direction,
when m<0, the light flux incident on the optical deflector is divergent in the main scanning direction, and
when m>0, the light flux incident on the optical deflector is convergent in the main scanning direction.

If the degree of convergence m is not equal to zero, main scanning jitter due to shift decentering of the deflection surface of the optical deflector will occur. Therefore, it is preferred that the degree of convergence be kept within the range defined by the following condition:

|m|<0.2.

In this embodiment, the light flux incident on the deflection surface is parallel with respect to the main scanning direction, and therefore jitter due to shift decentering of the deflection surface of the optical deflector does not occur.

In this embodiment, two light fluxes are made incident on each of the different deflection surfaces 5a, 5′a of the single optical deflector 5, whereby the optical scanning apparatus that can scan the photosensitive drums for four colors, or yellow (Y), magenta (M), cyan (C), and black (Bk), simultaneously is provided.

In the case of the optical scanning apparatus of the type that uses one optical deflector and perform scanning on two opposite sides of the optical deflector as with the apparatus according to this embodiment, the optical deflector is typically disposed between two inner photosensitive drums among four photosensitive drums. The imaging lens closest to the optical deflector is disposed at away from the optical deflector by a substantially predetermined distance. In most cases, the imaging lens closest to the optical deflector is usually disposed just below the inner photosensitive drum, as shown in FIG. 1. Therefore, in the optical scanning apparatus of the type in which scanning is performed on two opposite sides of the optical deflector, the degree of freedom in the arrangement of the optical components is low, because it is necessary that arrange the light fluxes be arranged to be kept away from the imaging lens closest to the optical deflector.

On the other hand, in the case of the optical scanning apparatus of the type that perform scanning on one side of one optical deflector, the distance between the optical deflector and the photosensitive drum can be changed to some extent (that is, the positional relationship between the imaging lens closest to the optical deflector and the photosensitive drum can be changed). Therefore, the problem of interference of the imaging lens closest to the optical deflector and a light flux is unlikely to be encountered with this type of apparatus.

In this embodiment, at least one of the surface vertex (or virtual surface vertex) of the incidence surface of the imaging lens (or transmission type imaging optical element) 7B and the surface vertex (or virtual surface vertex) of the emergence surface of the imaging lens (or transmission type imaging optical element) 7B is arranged in the following manner in the sub-scanning section.

At least one of the aforementioned surface vertices is decentered from the center CL of the outer shape of the imaging lens 7B toward the same side as the optical path of the light flux Ra deflected by the deflection surface 5a and traveling toward the optical path folding mirror M1 of the other imaging optical system among the plurality of imaging optical systems.

In this embodiment, an increased degree of freedom in the arrangement of optical components is achieved. For this purpose, the principal ray Rbo of the light flux Rb (R′b) passes through the imaging lens 7B (7′B) on the side opposite to the optical path of the light flux Ra (R′a) traveling toward the optical path folding mirror M1 (M′1) with respect to the optical axis PL of the lens.

In addition, the center CL of the outer shape of the imaging lens 7B (7′B) is designed to be on the opposite side of the optical path of the light flux traveling toward the optical path folding mirror M1 (M71) with respect to the optical axis PL of the lens.

In other words, in this embodiment, the imaging lens 7B (7′B) is designed to have an asymmetrical shape with respect to the center CL of the outer shape of the imaging lens 7B (7′B) in the sub-scanning section so that it does not interfere with the light flux Ra (R′a) traveling toward the optical path folding mirror M1.

Thus, in this embodiment, an increased degree of freedom in the arrangement of optical components is achieved, and a compact optical scanning apparatus is provided.

FIG. 3 is an enlarged view of the imaging lens 7B (7′B) shown in FIG. 1 taken on the sub-scanning section. In FIG. 3, the imaging lens 7B (7′B) used in this embodiment (in stations S2 and S3) is shown as Type 1, and an imaging lens that has been conventionally used is shown as Type 2.

Line CL is the center line of the outer shape (or the outer shape center) of the lens in the sub scanning direction. Line PL is the line connecting the surface vertex of the incidence surface of the imaging lens 7B (7′B) and the surface vertex of the emergence surface of the imaging lens 7B (7′B). Line Rbo represents the principal ray of the light flux (or scanning light flux) Rb (R′b).

In this embodiment, the principal ray Rbo of the light flux Rb (R′b) passes through the imaging lens 7B (7′B) on the side opposite to the optical path of the light flux (not shown in FIG. 3) traveling toward the optical path folding mirror M1 (M′1) with respect to the optical axis PL of the lens, as described above.

In addition, the center CL of the outer shape of the imaging lens 7B (7′B) is located on the side opposite to the light flux (not shown in FIG. 3) traveling toward the optical path folding mirror M1 (M′1) with respect to the optical axis PL of the lens.

In other words, in this embodiment, the imaging lens 7B (7′B) is designed to have an asymmetrical shape with respect to the center CL of the outer shape of the imaging lens 7B (7′B) in the sub-scanning section so that it does not interfere with the light flux (not shown in FIG. 3) traveling toward the optical path folding mirror M1.

Furthermore, the imaging lens 7B (7′B) in this embodiment has a thickness T1 at the upper end (in FIG. 3) of the lens surface (i.e. the outer thickness of the imaging lens 7B (7′B) on the side opposite to the optical path of the light flux traveling toward the optical path folding mirror M1 (M′1) with respect to the center CL of the outer shape of the imaging lens 7B (7′B)) In addition, the imaging lens 7B (7′B) has a thickness T2 at the lower end (i.e. the outer thickness of the imaging lens 7B (7′B) on the side of the optical path of the light flux traveling toward the optical path folding mirror M1 (M′1) with respect to the center of the outer shape of the imaging lens 7B (7′B)). Thickness T1 and thickness T2 satisfy the following relationship:

T1<T2.

Thus, the imaging lens 7B (7′B) has an asymmetric shape with respect to the center of the outer shape in which the outer thickness T1 at the upper end is smaller than the outer thickness T2 at the lower end.

In this embodiment, the light flux Rb (R′b) passes through the imaging lens 7B (7′B) at a position substantially close to the center line CL of the outer shape of the lens. Therefore, in the imaging lens 7B (7′B) according to this embodiment, useless portion thereof has been eliminated unlike with imaging lenses that have been conventionally used.

On the other hand, in the case of the conventional imaging lens shown as Type 2, the center line CL of the outer shape of the lens and the line PL connecting the surface vertices coincide with each other. Therefore, the thickness T1 at the upper end (in FIG. 3) of the lens surface and the thickness T2 at the lower end of the lens surface satisfy the following relationship:

T1=T2.

However, in the imaging lens of Type 2, the light flux Rb (R′b) passes through the lens at a position remote from the center line CL of the outer shape of the lens. Therefore, there is a large non-effective area through which the light flux Rb (R′b) does not pass.

The use of a lens like this having a large dimension or height along the sub-scanning direction has made it difficult heretofore to achieve compactness of the optical scanning apparatus.

In this embodiment, the non-effective area through which no light flux passes has been eliminated, and the light fluxes and the optical components are arranged as close as possible to each other, as will be apparent from FIGS. 1 and 3 (Type 1), whereby the degree of compactness of the optical scanning apparatus is further increased (i.e. the thickness of housing 10 shown in FIG. 1 is decreased).

Furthermore, as is the case with the thie embodiment, arranging the imaging lens 7B (7′B) having an asymmetrical shape with respect to the center CL of the outer shape in the imaging optical system SB (S′B) in the station S2 (S3) closest to the optical deflector 5 effectively improves the compactness of the apparatus.

The imaging optical system SB (S′B) of the station S2 (S3) closest to the optical deflector 5 typically has a plurality of optical path folding mirrors to fold the optical path, and the arrangement of the optical path is complex in this optical system. For this reason, interference of the imaging lens and the light flux is likely to occur. As is the case with this embodiment, use of the imaging lens 7B (7′B) that is decentered with respect to the sub-scanning direction with respect to the center CL of the outer shape of the lens is greatly advantageous in achieving the compactness.

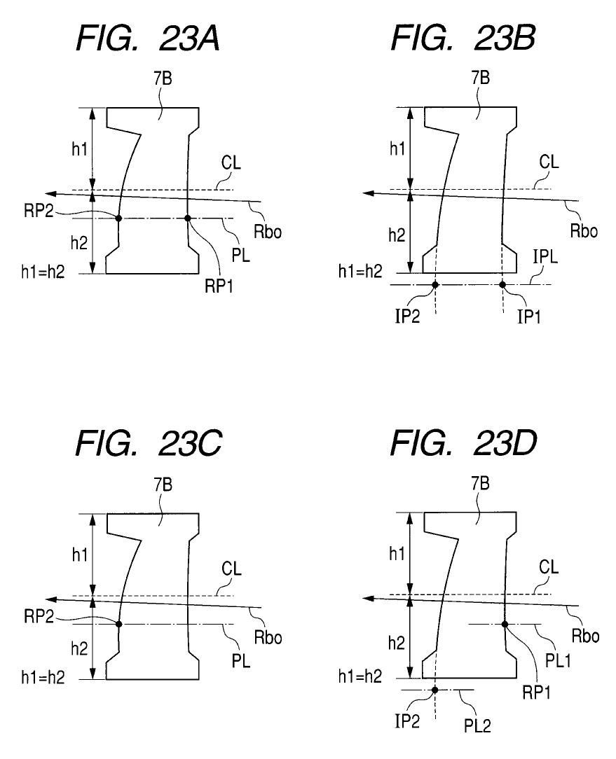

Here, a supplemental description of decentering of the surface (or the shift decentering of surface vertices) will be made with reference to drawings. FIGS. 23A to 23D shows various types of surface decentering. FIG. 23A shows a type in which the surface vertex RP1 of the incidence surface and the surface vertex RP2 of the emergence surface are both on the lens surfaces as is the case with the imaging lens in this embodiment. The straight line PL connecting the vertices is referred to as the lens optical axis. In the case of this type, the surface vertices are shifted along the sub-scanning direction (in the lens height direction) from the center of the outer shape of the lens by the same amount, and therefore the lens optical axis PL and the center line CL are parallel to each other. Here, the surface vertex is defines as the point on a circle that fits the sectional shape of the lens in the sub-scanning section that is protruded or recessed most in the direction of optical axis of the scanning optical system.

FIG. 23B shows a type that does not have surface vertices on the lens surfaces, but has virtual surface vertices (IP1, IP2) outside the outer shape of the lens.

Therefore, lens shown in FIG. 23B has a virtual lens optical axis PL outside the outer shape of the lens.

This type of lens may be used according to some design of the scanning optical system.

In this case also, the increased degree of freedom in the arrangement of optical components is achieved. To this end, the principal ray Rbo of the light flux Rb (R′b) passes through the imaging lens 7B (7B′) at a position on the side opposite to the optical path of the light flux Ra (R′a) traveling toward the optical path folding mirror M1 (M′1) with respect to the lens optical axis PL.

FIG. 23C shows a type in which the sectional shape of one surface in the sub-scanning section is flat.

In the case where the surface is flat in the sub-scanning section, the surface vertex cannot be defined. Here, the lens optical axis is defined as follows.

The lens optical axis PL is defined as the line that passes through the surface vertex RP2 of the surface having a curvature and extend parallel to the center line CL of the outer shape of the lens.

Lastly, the type shown in FIG. 23D will be described.

This type of lens has a surface vertex RP1 of one surface (incidence surface) located on the lens surface and a virtual surface vertex IP2 of the other surface (emergence surface) located outside the outer shape of the lens.

In the present invention, the lens may have, in contrast, a surface vertex RP2 of the emergence surface located on the lens surface and a virtual surface vertex IP1 of the incidence surface located outside the outer shape of the lens.

In this case, it does not make sense to define the lens optical axis as the straight line connecting the two surface vertices. In this type of lens, the lines passing through the surface vertices RP1 and IP2 and extending parallel with the center line CL of the outer shape of the lens are respectively defined as axes PL1, PL2 in the same way as the case shown in FIG. 23C. It is preferred that the axes PL1 and PL2 be designed to be on the same side as the optical path of the light flux Ra (R′a) traveling toward the optical path folding mirror M1 (M′1) with respect to the center CL of the outer shape of the lens.

Various types of shift decentering of the surface vertices have been described in the foregoing. In addition to them, at least one of the surface vertices or the virtual surface vertices of the incidence surface and the emergence surface may be designed to be on the same side as the optical path of the light flux Ra (R′a) traveling toward the optical path folding mirror M1 (M′1) with respect to the center CL of the outer shape of the lens. By this design, the degree of freedom in the arrangement of optical components is increased, the size of the overall apparatus can be reduced, and interference of the imaging lens and light fluxes can be prevented.

Such downsizing of the optical scanning apparatus leads to downsizing of the image forming apparatus. Alternatively, the capacity of a toner container(s) used in the image forming apparatus can be increased without an increase in the size of the image forming apparatus.

In this embodiment, the imaging lens 7A (7′A) in the station S1 (S4) also has a shape that is asymmetrical with respect to the center of the outer shape of the imaging lens 7A (7′A).

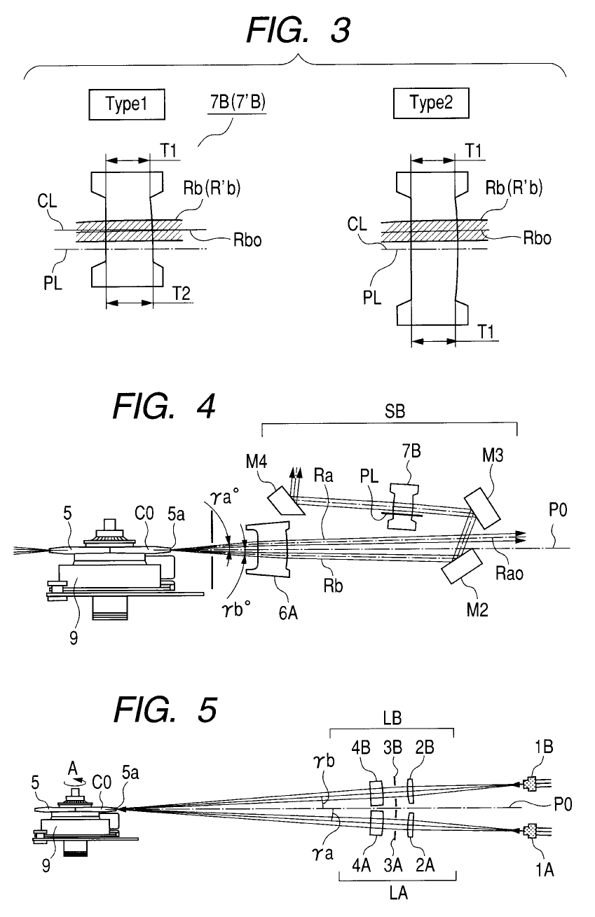

FIG. 4 is an enlarged view taken on the sub-scanning section showing a portion including the optical deflector and the relevant components of the imaging optical system SB shown in FIG. 1. Components same as those shown in FIG. 1 are denoted by the same reference signs.

In FIG. 4, the plane that is perpendicular to the same deflection surface 5a of the optical deflector 5 and contains the reference point C0 is denoted by sign P0. A plurality of (or two) light fluxes respectively having oblique incidence angles ya=3.3° and yb=3.3° with respect to plane P0 are deflectively scanned.

If the oblique incidence angles ya, yb are too large, it is difficult to correct corruption or deformation of the spot caused by twisting of wavefront aberration. If the oblique incidence angles ya, yb are too small, it is difficult to separate the optical paths.

In this embodiment, the oblique incidence angles ya, yb are set to the same angle of 3.3° for both the upper and lower light fluxes to thereby facilitate separation of the optical paths by the optical path folding mirror M2 (M′2).

FIG. 5 is a cross sectional view of the incidence optical system according to this embodiment taken on the sub-scanning section. Components the same as those shown in FIG. 2 are denoted by the same reference signs.

In this embodiment, semiconductor lasers 1A, 1B are used as the light source unit. Divergent light fluxes emitted from the semiconductor lasers 1A, 1B are collimated into parallel light fluxes by the coupling lenses 2A, 2B. In the sub-scanning direction, the light fluxes collimated by the coupling lenses 2A, 2B are once focused at positions near the same deflection surface 5a of the optical deflector 5 by cylindrical lenses 4A, 4B. Stops 3A, 3B restrict the widths of the light fluxes so that desired spot diameters (i.e. the diameter of the spot sliced at a light quantity of 1/e² times the peak light quantity) are achieved on the respective scanned surfaces. By using common optical components in this way, the number of types of the optical components is reduced, and advantages of mass production can be enjoyed by an increase in the production of each component.

The optical deflector (or polygon mirror) 5 serving as the deflection unit shown in FIG. 5 has five surfaces and a circumcircle radius of 17 mm. The optical deflector 5 is rotated by a motor 9 at a constant speed in the direction indicated by arrow A in FIG. 2, whereby the scanned surface 8B (8A) is scanned in the direction indicated by arrow B (i.e. the main scanning direction).

The imaging optical system (not shown) focuses the light flux representing image information deflectively scanned by the optical deflector 5 onto the scanned surface or the surface of the photosensitive drum as a light spot in the main scanning section (in the main scanning direction). In addition, the deflection surface of the optical deflector 5 and the surface of the photosensitive drum are designed to be optically conjugate with each other, whereby optical face angle error correction is achieved.

In a typical optical deflector, such as a polygon mirror, that has a plurality of deflection surfaces, the inclination angles of the deflection surfaces in the sub-scanning direction are different from each other. For this reason, an optical face angle error correction optical system is generally used.

In this embodiment, the divergent light flux emitted from the semiconductor laser 1A is converted into a parallel light flux by the coupling lens 2A, the light flux is restricted (in terms of light quantity) by the aperture stop 3A restricts when passing through it, and then the light flux is incident on a cylindrical lens 4A. The parallel light flux incident on the cylindrical lens 4A emerges from it without being changed in the main scanning section, and is incident on the deflection surface 5a of the optical deflector 5. The light flux is designed to be incident on the deflection surface 5a so that the optical axis of the imaging lens 6A and the principal ray of the light flux form an angle α of 70°.

In this embodiment, the imaging magnification βs of the imaging optical system in the sub-scanning section satisfies the following condition (1):

1.0<|βs|<2.2 (1).

Condition (1) limits the imaging magnification of the imaging optical system in the sub-scanning section. Exceeding the upper limit of condition (1) undesirably leads to an increase in the degree of pitch unevenness attributed to an optical face angle error and insufficiency in wavefront aberration correction. On the other hand, if the lower limit of condition (1), the imagine lens close to the scanned surface is required to be made unduly close to the scanned surface. This is not desirable because this requires an increased length of the imaging lens and reduces the degree of freedom in the arrangement.

In this embodiment, the value of the imaging magnification βs of the imaging optical system is −1.98, which satisfies condition (1).

It is more preferred that condition (1) be modified as follows:

1.2<|βs|<2.0 (1a).

The shape and the optical arrangement of each lens in the optical scanning apparatus according to this embodiment are presented in Table 1. Table 1 specifies the surface shape of the optical elements in the imaging optical system SA through which the light flux Ra passes and the optical arrangement thereof in the state in which the optical path is developed. The imaging optical systems for the other light fluxes Rb, R′a, R′b are the same as the imaging optical system SA, and specific numerical values that specify the lens surface shapes in them are not presented.

In Table 1, the fθ lens 6 refers to the imaging lens 6A (6′A), and the fθ lens 7 refers to the imaging lens 7A, 7B (7′A, 7′B).

TABLE 1
configuration of light scanning apparatus

| fθ coefficient, Scanning width, field angle | | | shape of Coupling lens 2 | | | | | |
|---|---|---|---|---|---|---|---|---|
| fθ coefficient | K | 210.00 | | incidence | emergence | | | |
| | (mm/rad) | | | surface 2a | surface 4b | | | |
| scanning width | W (mm) | 310.00 | R | ∞ | −35.14 | | | |
| maximum field angle | θmax | 42.29 | meridional shape of cylindrical lens 4 | | | saggital shape of cylindrical lens 4 | | |
| | (deg) | | | | | | | |
| wavelength, refractive index | | | | incidence | emergence | | incidence | emergence |
| | | | | surface 4a | surface 4b | | surface 4a | surface 4b |
| used wavelength | λ(nm) | 790.0 | R | ∞ | ∞ | Rs | 56.5 | ∞ |
| refractive index of | N1 | 1.76167 | meridional shape of fθ lens 6 | | | saggital shape of fθ lens 6 | | |
| coupling lens 2 | | | | | | | | |
| refractive index of | N2 | 1.51052 | | incidence | emergence | | incidence | emergence |
| cylindrical lens 4 | | | | surface 6a | surface 6b | | surface 6a | surface 6b |
| refractive index of fθ | N3 | 1.52397 | | anti-light | anti-light | | anti-light | anti-light |
| lens 6 | | | | source side | source side | | source side | source side |
| refractive index of fθ | N4 | 1.52397 | R | −7.26244E+01 | −4.30596E+01 | Rs | 5.00000E+02 | −3.27935E+01 |
| lens 7 | | | | | | | | |
| incidence optical system arrangement | | | Ke | 2.91659E+00 | −2.17420E−01 | D2e | 0.00000E+00 | 8.56647E−05 |
| incidence angle in | α (deg) | 70.00 | B4e | −7.83532E−07 | −5.04281E−07 | D4e | 0.00000E+00 | 2.82218E−08 |
| main scanning | | | | | | | | |
| direction | | | | | | | | |
| incidence angle in | γ (deg) | 3.30 | B6e | 8.09180E−09 | 1.99884E−09 | D6e | 0.00000E+00 | −1.68952E−11 |
| sub-scanning | | | | | | | | |
| direction | | | | | | | | |
| light source 1 - | d0 (mm) | 45.00 | B8e | −9.23423E−12 | 6.03260E−13 | D8e | 0.00000E+00 | 0.00000E+00 |
| incidence lens | | | | | | | | |
| surface 2a | | | | | | | | |
| incidence lens | d1 (mm) | 2.00 | B10e | 3.31468E−15 | −2.03097E−15 | D10e | 0.00000E+00 | 0.00000E+00 |
| surface 2a - | | | | | | | | |
| emergence lens | | | | | | | | |
| surface 2b | | | | | | | | |
| emergence lens | d2 (mm) | 5.00 | | light source | light source | | light source | light source |
| surface 2b - stop 3 | | | | side | side | | side | side |
| stop 3 - incidence | d3 (mm) | 5.00 | R | −7.26244E+01 | −4.30596E+01 | Rs | 5.00000E+02 | −3.27935E+01 |
| lens surface 4a | | | | | | | | |
| incidence lens | d4 (mm) | 5.00 | Ks | 2.91659E+00 | −2.17420E−01 | D2s | 0.00000E+00 | 2.57239E−05 |
| surface 4a - | | | | | | | | |
| emergence lens | | | | | | | | |
| surface 4b | | | | | | | | |
| emergence lens | d5 (mm) | 108.00 | B4s | −7.83532E−07 | −5.04281E−07 | D4s | 0.00000E+00 | 3.87663E−08 |
| surface 4b - | | | | | | | | |
| deflection reference | | | | | | | | |
| point C0 | | | | | | | | |
| stop shape | | oval | B6s | 8.09180E−09 | 1.99884E−09 | D6s | 0.00000E+00 | −1.07545E−11 |
| stop diameter in | eay | 4.60 | B8s | −9.23423E−12 | 6.03260E−13 | D8s | 0.00000E+00 | 0.00000E+00 |
| main scanning | (mm) | | | | | | | |
| direction | | | | | | | | |
| stop diameter in | eaz | 3.96 | B10s | 3.31468E−15 | −2.03097E−15 | D10s | 0.00000E+00 | 0.00000E+00 |
| sub-scanning | (mm) | | | | | | | |
| direction | | | | | | | | |
| optical deflector | | | fθ lens 7 meridional shape | | | saggital shape of fθ lens 7 | | |
| number of polygon | | 5 | | incidence | emergence | | incidence | emergence |
| surfaces | | | | surface 7a | surface 7b | | surface 7a | surface 7b |
| radius of | Rpol | | | anti-light | anti-light | | anti-light | anti-light |
| circumcircle | (mm) | 17 | | source side | source side | | source side | source side |
| rotation center - | Xpol | 11.945 | R | −1.20289E+04 | 4.77512E+02 | Rs | 2.67651E+02 | −4.33509E+01 |
| deflection reference | (mm) | | | | | | | |
| point C0 (X | | | | | | | | |
| direction) | | | | | | | | |
| rotation center - | Ypol | 6.198 | Ke | 0.00000E+00 | −1.16468E+02 | D2e | −4.78914E−05 | 1.00421E−04 |
| deflection reference | (mm) | | | | | | | |
| point C0 (Y | | | | | | | | |
| direction) | | | | | | | | |
| scanning optical system arrangement | | | B4e | 0.00000E+00 | −1.72972E−07 | D4e | −1.56436E−08 | −1.86020E−08 |
| deflection reference | L0 (mm) | 27.20 | B6e | 0.00000E+00 | 1.28348E−11 | D6e | 1.37062E−12 | 6.01693E−12 |
| point C0 - incidence | | | | | | | | |
| lens surface 6a | | | | | | | | |
| incidence lens | L1 (mm) | 9.00 | B8e | 0.00000E+00 | −6.58473E−16 | D8e | −5.36075E−17 | −8.59144E−16 |
| surface 6a - | | | | | | | | |
| emergence lens | | | | | | | | |
| surface 6b | | | | | | | | |
| emergence lens | L2 (mm) | 75.20 | B10e | 0.00000E+00 | 1.50313E−20 | D10e | 7.63315E−21 | 7.66171E−20 |
| surface 6b - | | | | | | | | |
| incidence lens | | | | | | | | |
| surface 7a | | | | | | | | |
| incidence lens | L3 (mm) | 5.00 | | light source | light source | | light source | light source |
| surface 7a - | | | | side | side | | side | side |
| emergence lens | | | | | | | | |
| surface 7b | | | | | | | | |
| emergence lens | L4 (mm) | 129.10 | R | −1.20289E+04 | 4.77512E+02 | Rs | 2.67651E+02 | −4.33509E+01 |
| surface 7b - | | | | | | | | |
| scanned surface 8 | | | | | | | | |
| polygon deflection | L total | 246.00 | Ks | 0.00000E+00 | −1.16468E+02 | D2s | −4.78914E−05 | 7.54387E−05 |
| surface 5a - | | | | | | | | |
| scanned surface 8 | | | | | | | | |
| sub-scanning | shift z | 1.581 | B4s | 0.00000E+00 | −1.72972E−07 | D4s | −1.56436E−08 | −8.55953E−10 |
| decentering amount | (mm) | | | | | | | |
| of lens 7 | | | | | | | | |
| inclination | RotZ | 0.544 | B6s | 0.00000E+00 | 1.28348E−11 | D6s | 1.37062E−12 | −7.09768E−13 |
| decentering amount | (minute) | | | | | | | |
| of lens 7 | | | | | | | | |
| | | | B8s | 0.00000E+00 | −6.58473E−16 | D8s | −5.36075E−17 | 2.60979E−16 |
| | | | B10s | 0.00000E+00 | 1.50313E−20 | D10s | 7.53315E−21 | 6.63885E−21 |

Table 1 specifies the shape and arrangement of the lenses in the imaging optical system SA.

The meridional shapes of the incidence lens surface and the emergence lens surface of the imaging lenses 6A, 7A, and 7B are aspheric shapes represented by tenth order function. The shape of the lens surface in the meridional direction corresponding to the main scanning direction is expressed by the following formula:

$$X = \frac{{Y}^{2} / R}{1 + {( 1 - ( 1 + K ) {( Y / R )}^{2} )}^{1 / 2}} + {B}_{4} {Y}^{4} + {B}_{6} {Y}^{6} + {B}_{8} {Y}^{8} + {B}_{10} {Y}^{10}$$

where the origin is located at the point of intersection of the lens surface of each imaging lens 6A, 7A, 7B and the optical axis thereof, the X axis is taken along the optical axis direction, the Y axis is taken as the axis that is perpendicular to the optical axis in the main scanning section, R is the meridional curvature radius, and K, B₄, B₆, B, and B₁₀ are aspheric coefficients.

The values of the aspheric coefficients B₄, B₆, B₈, B₁₀ may be different between those (B₄ₛ, B₆ₛ, B₈ₛ, B₁₀ₛ) on the side of the optical scanning apparatus on which the semiconductor laser 1A is disposed and those (B₄ₑ, B₆ₑ, B₈ₑ, B₁₀ₑ) disposed on the side thereof on which the semiconductor laser 1A is not disposed. Thus, a shape that is asymmetrical in the main scanning direction can be expressed.

The shape of the lens surface in the sagittal direction corresponding to the sub-scanning direction is expresses by the following formula:

$$S = \frac{\frac{{Z}^{2}}{{Rs}^{*}}}{1 + \sqrt{1 - {( \frac{Z}{{Rs}^{*}} )}^{2}}}$$

where S is the sagittal shape defined in the plane containing the normal of the medirional line at each position with respect to the meridional direction and perpendicular to the main scanning cross section.

The curvature radius (or the sagittal curvature radius) Rs* in the sub-scanning direction at a position distant from the optical axis by distance Y along the main scanning direction is represented by the following formula:

Rs*=Rs×(1+D2×Y²+D4×Y⁴+D6×Y⁶+D8×Y⁸+D10×Y¹⁰)

where Rs is the sagittal curvature radius on the optical axis, and D₂, D₄, D₆, D₈, and D₁₀ are sagittal variation coefficients.

This also may be set in a manner similar to the shape in the main scanning direction. Namely, The values of the aspheric coefficients D₂, D₄, D₆, D₈, D₁₀ may be different between those (D₂ₛ, D₄ₛ, D₆ₛ, D₈ₛ, D₁₀ₛ) on the side on which the semiconductor laser 1A is disposed and those (D₂ₑ, D₄ₑ, D₆ₑ, D₈ₑ, D₁₀ₑ) disposed on the side on which the semiconductor laser 1A is not disposed. Thus, a shape that is asymmetrical in the main scanning direction can be expressed.

Although in the this embodiment, the function representing the surface shape is defined by the above formulas, the scope of the present invention is not limited to this.

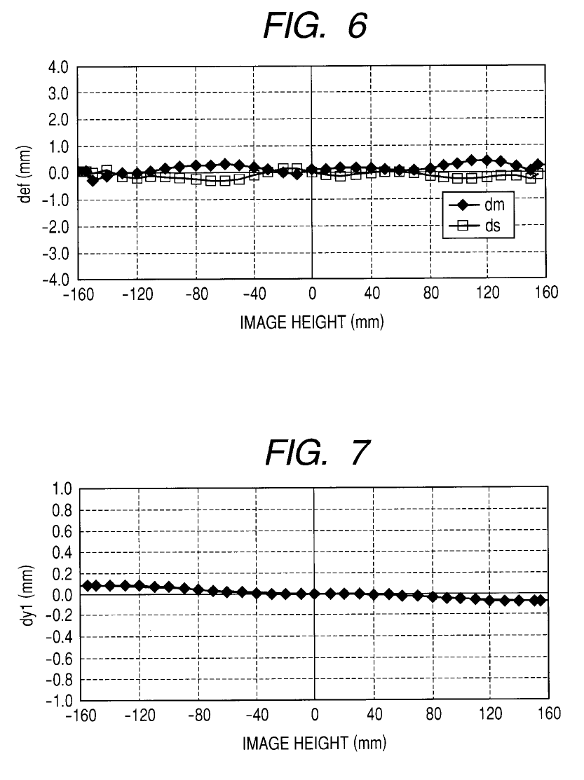

FIG. 6 is a graph showing curvature of field in the main scanning direction and the sub-scanning direction in the first embodiment of the present invention.

The imaging optical system SA has a curvature of field dm of 0.72 mm in the main scanning direction, and a curvature of field ds of 0.46 mm in the sub-scanning direction within the effective width of the image (W=310 mm). It will be understood from this that curvature of field is excellently corrected.

FIG. 7 is a graph showing the fθ characteristic dy1 in the first embodiment of the present invention.

The fθ characteristic dy1 is represented by the difference obtained by subtracting the ideal image height from the height at which the light flux actually arrives. In this imaging optical system SA, the maximum deviation is 8.5 μm. It will be understood from this that excellent correction is achieved.

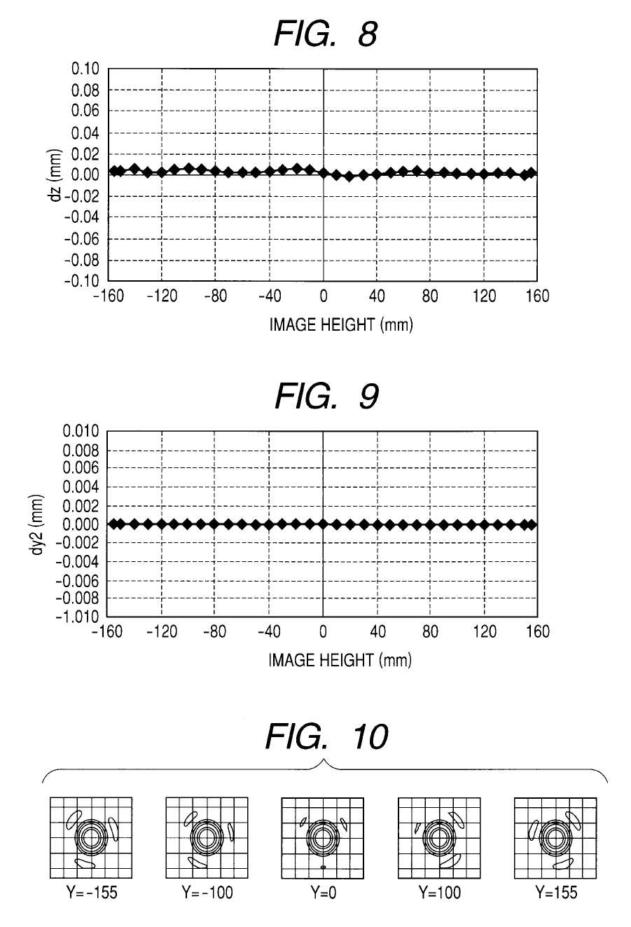

FIG. 8 is a graph showing the scanning line bending dz in the first embodiment of the present invention.

The scanning line bending dz is represented by the difference or distance between the imaging position with respect to the sub-scanning direction at each image height and the imaging position with respect to the sub-scanning direction at the center of the image. In this imaging optical system SA, the maximum value of the difference is 7 μm, which does not significantly affect the image quality.

In this embodiment, the imaging lens 7A is oriented at a rotational angle of 0.544 minute about a rotational axis the same as its optical axis in the clockwise direction as seen from the optical deflector. The imaging lens 7B is oriented at a rotational angle of 0.544 minute about a rotational axis the same as its optical axis in the anticlockwise direction as seen from the optical deflector. This helps correction of inclination of scanning lines.

FIG. 9 is a graph showing the jitter dy2 in the main scanning direction under the presence of a 10-μm shift decentering error of the deflection surface.

In the imaging system SA, the jitter in the main scanning direction (or the main scanning jitter) is 0.1 μm at maximum. As described before, if a light flux that is parallel in the main scanning section is incident on the optical deflector, no main scanning jitter occurs.

FIG. 10 illustrates the cross sectional shape of the light spot at some image heights.

FIG. 10 shows sections of the spot at each image height sliced at 2%, 5%, 10%, 13.5%, 36.8%, and 50% of the peak light quantity.

In optical scanning apparatuses in which light fluxes are incident on the deflection surface from oblique directions in the sub-scanning section, corruption of the spot generally occurs due to twisting of wavefront aberration. In this embodiment, twisting of wavefront aberration is reduced by optimizing the power arrangement of lens surfaces, the amount of tilt of a lens(es), and the amount of shift of a lens(es). In the case of the imaging optical system SA, the imaging lens 7A is shifted in the sub-scanning direction by 1.58 mm relative to plane P0 to thereby correct wavefront aberration. By this feature, fine spot shape without corruption is achieved at all image heights.

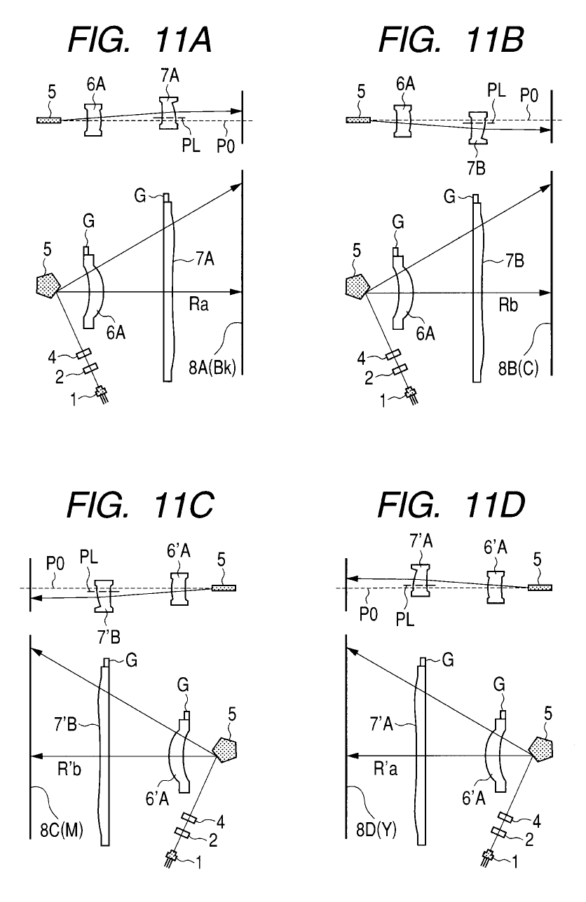

FIGS. 11A to 11D show developed optical paths of the respective light flux (or the respective stations) of the optical scanning apparatus shown in FIG. 1, in the main scanning section and the sub-scanning section.

FIG. 11A shows how the light flux Ra guided to the scanned surface 8A (Bk) passes the relavant optical elements. In FIGS. 11A and 11B, the light flux Ra traveling toward the scanned surface 8A (Bk) and the light flux Rb traveling toward the scanned surface 8B (C) pass through different regions of the common imaging lens 6A in the sub-scanning section. In addition, it will be understood that the imaging lens 7A and the imaging lens 7B must be different kinds of lenses in view of their shapes (such as the orientation of the gate G) with respect to the main scanning direction.

In FIGS. 11C and 11D, the light flux R′b traveling toward the scanned surface 8C (M) and the light flux R′a traveling toward the scanned surface 8D (Y) pass through different regions of the common imaging lens 6′A in the sub-scanning section. In addition, it will be understood that the imaging lens 7′A and the imaging lens 7′B must be different kinds of lenses in view of their shapes (such as the orientation of the gate G) with respect to the main scanning direction.

To sum up, the imaging lens 6A and the imaging lens 6′A may be lenses of the same kind, and this kind can be used for all the four light fluxes. In contrast, two kinds of lenses are needed as the imaging lenses 7A, 7B, (7′A, 7′B) separately provided for the respective scanning light fluxes.

Nonetheless, the imaging lens 7A and 7′B are of the same kind, and the imaging lens 7B and the imaging lens 7′A are of the same kind.

Manufacturing and discrimination of these two kinds of imaging lenses 7A, 7B (7′A, 7′B) will be described in detail later.

In recent years, resonance type optical deflectors in which one deflection surface are oscillated have been vigorously developed. The use of such a resonance type optical deflector enables elimination of problems such as the aforementioned pitch unevenness attributed to an optical face angle error and the aforementioned main scanning jitter attributed to a surface decentering. Therefore, the advantages of this embodiment can be increased when used in combination with a resonance type optical deflector.

As described above, in this embodiment, the degree of freedom in the arrangement of optical components is increased and a compact optical scanning apparatus is achieved by configuring various components appropriately as described above.

Furthermore, according to this embodiment, a scanning apparatus that can achieve correction of twisting of wavefront aberration and other satisfactory paraxial characteristics.

### Second Embodiment

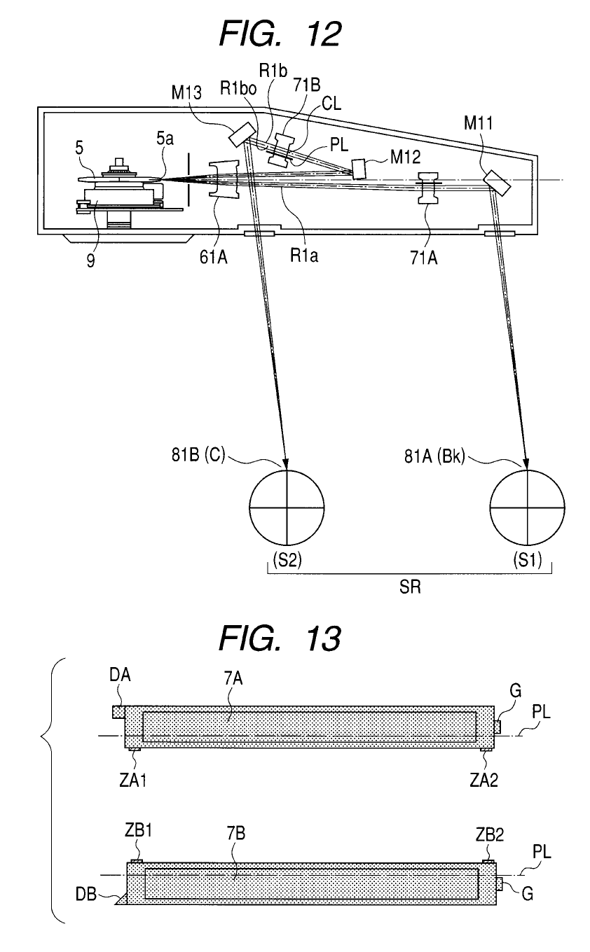

FIG. 12 is a cross sectional view taken along the sub-scanning direction (sub-scanning section), showing the relevant portions of an apparatus according to the second embodiment of the present invention. The components in FIG. 2 same as those shown in FIG. 1 are denoted by the same reference signs.

This embodiment differs from the above-described first embodiment in that the light scanning unit (or scanning unit SR) is disposed only on one side of the optical deflector 5. The configuration and the optical effect other than this is the same as the first embodiment, and the same effects are achieved.

Thus, in this embodiment, the present invention is applied to a optical scanning apparatus of a type in which the one optical deflector 5 is used to perform scanning only on one side thereof.

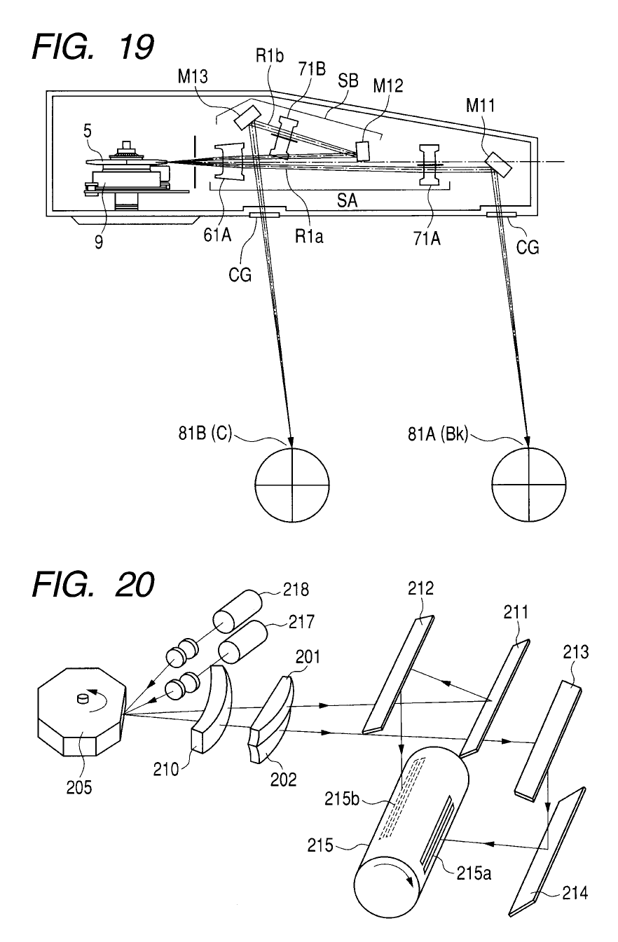

In the conventional optical scanning apparatus shown in FIG. 19 mentioned before, interference of the light flux R1b having passed through the imaging lens 61A and the imaging lens 71B (i.e. transmission type imaging optical element 71B) occurs. In this embodiment, use is made of an imaging lens 71B (i.e. transmission type imaging optical element 71B) that does not have useless portion through which no scanning light flux passes as described before, whereby interference of the light flux R1b and the imaging lens 71B can be prevented.

Furthermore, since the optical scanning apparatus according to this embodiment is of a type in which scanning is performed with a plurality of light fluxes only on one side of the optical deflector 5, the positional relationship between the optical deflector 5 and the photosensitive drum 81B (81A) can be changed. Therefore, the degree of freedom in the arrangement of optical components in this embodiment is higher than that in the above-described first embodiment.

Although in this embodiment, the present invention is applied to a optical scanning apparatus of a type having two stations S1, S2 that use the same deflection surface 5a of the optical deflector 5, the application of the present invention is not limited to this. The present invention may also be applied to a optical scanning apparatus of a type having only one station S2 (i.e. monochrome optical scanning apparatus).

This optical scanning apparatus is provided with light source unit, deflection unit for deflectively scanning a light flux emitted from the light source unit by a deflection surface, and an imaging optical system that focuses the light flux deflectively scanned by the deflection surface of the deflection unit onto a photosensitive drum.

In the sub-scanning section, the light flux is incident on the deflection surface of the deflection unit from an oblique direction.

The imaging optical system includes an optical path folding mirror M12.

The imaging optical system includes a transmission type imaging lens (or imaging optical element) 71B provided in the optical path between the optical path folding mirror M12 and the photosensitive drum 81B.

In this case, at least one of the surface vertex (or virtual surface vertex) of the incidence surface of the imaging lens (transmission type imaging optical element) 71B and the surface vertex (or virtual surface vertex) of the emergence surface of the imaging lens 71B is arranged as follows in the sub-scanning section.

At least one of the aforementioned surface vertices is decentered from the center CL of the outer shape of the imaging lens 71B toward the same side as the optical path of the light flux deflected by the deflection surface 5a and traveling toward the optical path folding mirror M12.

In the sub-scanning section, the principal ray R1bo of the light flux R1b passes through the imaging lens 71B located in the optical path between the optical path folding mirror M12 and the photo sensitive drum 81B on the side opposite to the optical path of the light flux R1b traveling toward the optical path folding mirror M12 with respect to the lens optical axis PL. In addition, the center CL of the outer shape of the imaging lens 71B is located on the side opposite to the optical path of the light flux R1b traveling toward the optical path folding mirror M12 with respect to the lens optical axis PL.

Here, it is assumed that the imaging lens 7B has a symmetrical shape in the sub-scanning section. The straight line connecting the surface vertex (or virtual surface vertex) of the incidence surface of this imaging lens 71B and the surface vertex (or virtual surface vertex) of the emergence surface of the imaging lens 71B is referred to as line PL. The portion of the element on the side opposite, with respect to this line PL, to the portion on which the light flux having been reflected by the optical path folding mirror M12 is incident has been cut away. Thus, the imaging lens 7B has an asymmetrical shape with respect to the center CL of the outer shape of the imaging lens 7B.

In this embodiment, a plurality of light source unit are provided. However, the present invention is not limited to this. For example, single light source unit having a plurality of light emitting portions (light emitting points) (e.g. a multi-beam semiconductor laser) may be used.

In this embodiment, if a color image composed of four colors (i.e. yellow (Y), magenta (M), cyan (C), and black (BK)) is to be formed, two optical scanning apparatuses like the above described optical scanning apparatus may be provided side by side.

### Third Embodiment

Manufacturing and discrimination of the two kinds of imaging lenses 7A, 7B (7′A, 7′B) will be described as a third embodiment of the present invention.

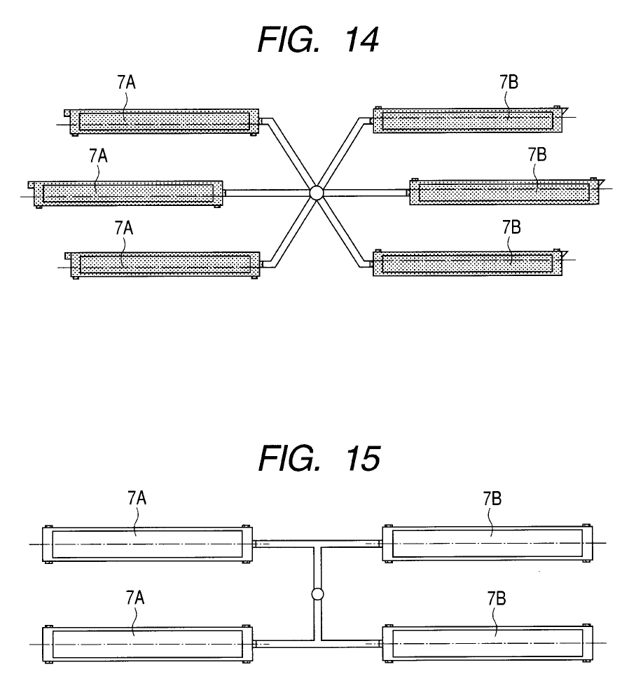

FIG. 13 illustrates the outer shape of the imaging lens 7A, 7B (7′A, 7′B) described in the first embodiment.

As described before, the lens surfaces of the imaging lenses 7A and 7B (7′A and 7′B) are defined by the same aspheric surface formula. However, in the sub-scanning section, the direction in which the lens optical axis PL (or meridional line) is shifted from the center of the outer shape thereof is different between them. Therefore, they are different kinds of imaging lenses if their shapes along the main scanning direction (i.e. the orientation of the gate G) are taken into consideration.

In this embodiment, in order to help discrimination between the imaging lens 7A and the imaging lens 7B, projecting portions DA and DB are provided outside the effective area of the imaging lenses 7A and 7B on the side opposite to the gates G, as shown in FIG. 13.

The imaging lenses 7A and 7B have the same shape except for the portions provided for discrimination. In particular, the positioning references ZA1, ZA2 and the positioning references ZB1, ZB2 for positioning with respect to the sub-scanning direction are provided at the same positions.

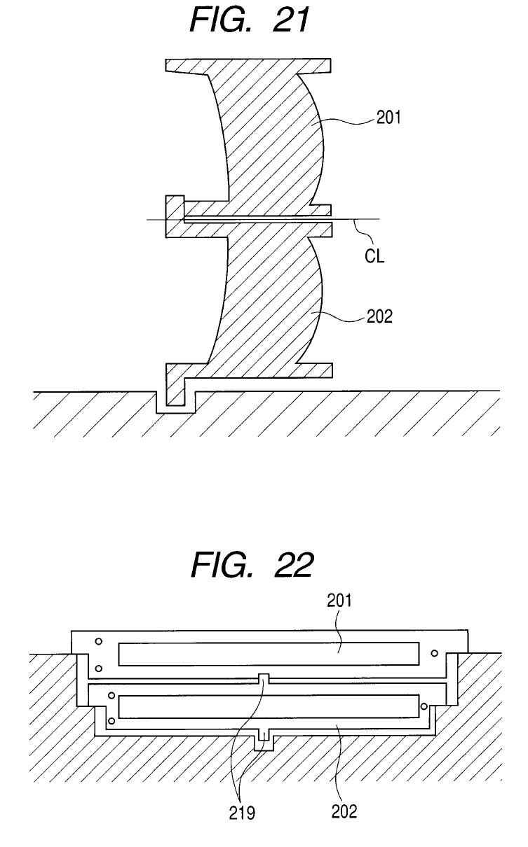

In this embodiment, a compact imaging lens is achieved without an unnecessary increase in the size of the outer shape of the effective portion of the lens, in contrast to the conventional lens shown in FIG. 22 in which the positioning reference 219 is shifted largely along the main scanning direction.

In the case of the conventional lens that has a symmetrical shape with respect to the center of the outer shape in the sub-scanning section, the cross sectional area of the lens is large, and the number of lenses that can be manufactured at the same time using one metal mold is as small as four, as shown in FIG. 15.

In the case of the imaging lens like that used in this embodiment that does not have useless portion through which no scanning light flux passes, the cross sectional area of the lens is smaller than that in the conventional lenses, and the number of lenses that can be manufactured at the same time is increased to six without an increase in the mold clamping force of the molding machine. The increase in the number of lenses in one batch from four to six leads to a decrease in the quantity of material used in one lens by a factor of approximately 2/3. This is very advantageous in manufacturing imaging lenses.

As shown in FIG. 14, two kinds of lenses can be molded at the same time using one metal mold by arranging three lenses of the type same as the imaging lenses 7A on the left side (in FIG. 14) and three lenses of the type same as the imaging lenses 7B on the right side.

This makes the number of types of metal molds (or the number of metal molds) smaller than that in the case where metal molds are prepared for respective types of lenses. Thus, the cost of the molds can be made smaller.

Thus, as is the case with this embodiment, use of the imaging lens that is asymmetrical in the sub-scanning direction with respect to the center of the outer shape of the lens is very advantageous in making the optical scanning apparatus compact and in achieving efficient manufacturing.

### Fourth Embodiment

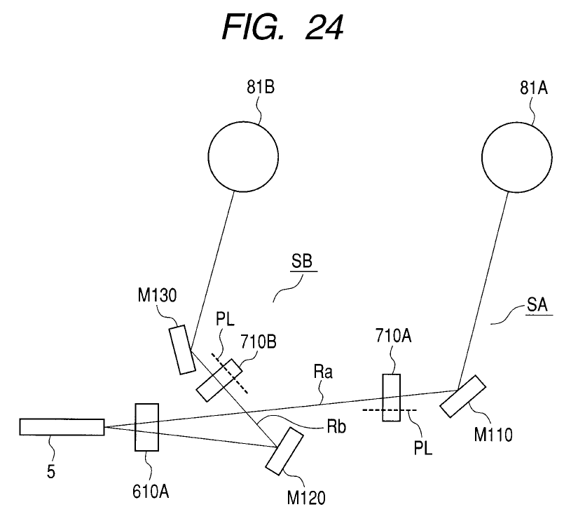

In the following, a fourth embodiment shown in FIG. 24 will be described. FIG. 24 shows an configuration in which the optical axis PL of the scanning imaging lens 710B is located on the side opposite to ray Ra with respect to ray Rb. The problem of interference between the lens and a light flux is not encountered with this configuration.

Nonetheless, eliminating the useless portion through which no scanning light flux passes is advantageous from the viewpoint of cost reduction, as discussed in the description of the third embodiment.

Therefore, the advantageous effects of the present invention are enjoyed also in the case of a optical scanning apparatus for a color image forming apparatus having the above-described type of arrangement of the light flux optical paths and in the case of a optical scanning apparatus for a monochrome image forming apparatus in which only one light flux is used and the problem of interference with other light fluxes does not arise.

The apparatus shown in FIG. 24 has an imaging lens 710A and an optical path folding mirror M110 of one imaging optical system SA, and optical folding mirrors M120 and M130 of another imaging optical system SB. The apparatus also has an imaging lens 610A.

### Color Image Forming Apparatus

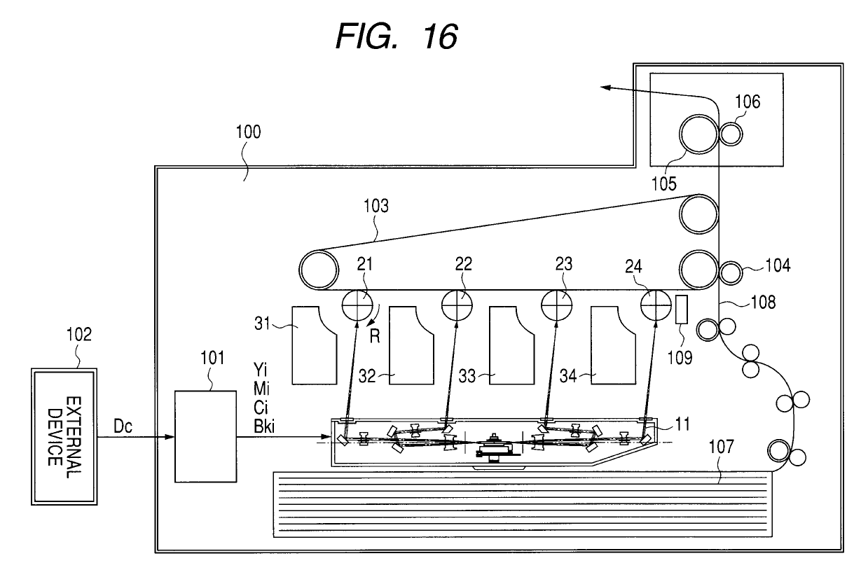

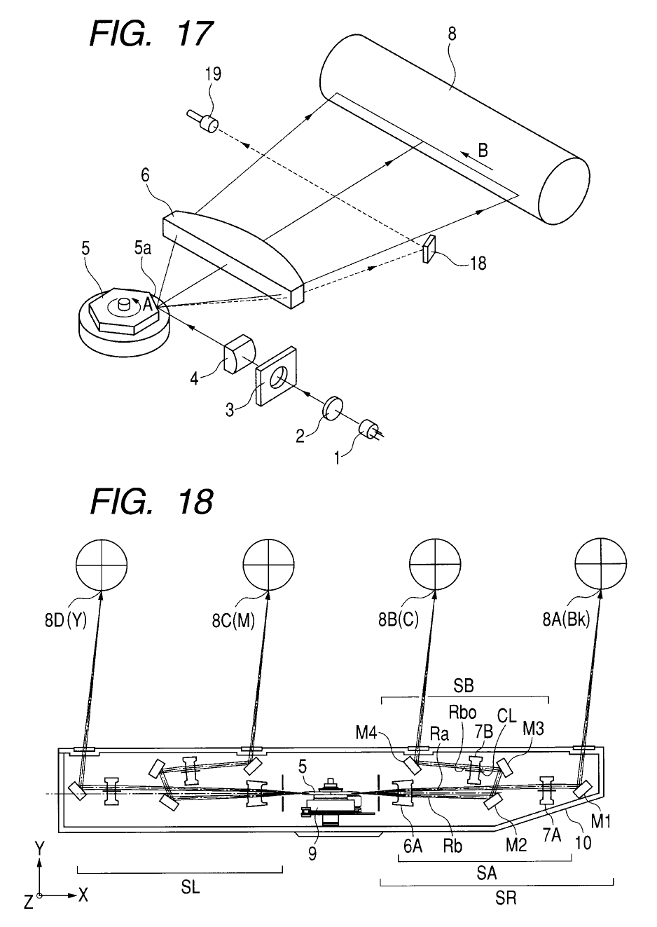

FIG. 16 is a cross sectional view in the sub-scanning direction, showing the relevant portions of an embodiment of a color image forming apparatus according to the present invention. To the color image forming apparatus 100 shown in FIG. 16 is input code data Dc, or a color signal, from an external device 102 such as a personal computer. The code data Dc is converted into respective color image data Yi (yellow), Mi (magenta), Ci (cyan), and Bki (black) by a printer controller 101 provided in the apparatus and input to a optical scanning apparatus 11 having the configuration like that according to the first or second embodiment. The optical scanning apparatus 11 emits light beams that have been modulated based on the image data Yi, Mi, Ci, and Bki. The surfaces of photosensitive drums 21 to 24 are scanned with these light beams in the main scanning direction.

The photosensitive drums 21 to 24 serving as electrostatic latent image bearing members (or photosensitive members) are rotated clockwise (in the direction indicated by arrow R) by a motor (not shown) With rotated, the photosensitive surfaces of the photosensitive drums 21 to 24 move in the sub-scanning direction perpendicular to the main scanning direction relative to the respective light beams. Above the photosensitive drums 21 to 24 are respectively provided charging rollers (not shown) that uniformly charge the surfaces of the photosensitive drums. The charging rollers are in contact with the surfaces of the corresponding photosensitive drums 21 to 24. The surfaces of the photosensitive drums 21 to 24 charged by the charging rollers are irradiated with the respective light beams scanned by the optical scanning apparatus 11.

As described above, the light beams have been modulated based on the image data Yi, Mi, Ci, and Bki, and electrostatic latent images are formed on the surfaces of the photosensitive drums 21 to 24 irradiated with the light beams. The electrostatic images are developed into toner images by developing devices 31 to 34 that are provided in such a way as to be in contact with the respective photosensitive drums 21 to 24 at positions downstream of the positions of irradiation with the light beams with respect to the rotation of the photosensitive drums 21 to 24.

The four color toner images developed by the developing devices 31 to 34 are once transferred onto an intermediate transfer belt 103 that is disposed above and opposed to the photosensitive drums 21 to 24, whereby a color image is formed thereon. Then the color toner image formed on the intermediate transfer belt 103 is transferred onto a paper sheet 108 serving as a transferred material by means of a transfer roller 104 by a transferring device (not shown). The paper sheets 108 are stored in a sheet cassette 107.

The paper sheet 108 on which an unfixed toner image has been transferred is further conveyed to a fixing device. The fixing device is composed of a fixing roller 105 having a fixing heater (not shown) provided in the interior thereof and a pressure roller 106 that is in pressure contact with the fixing roller 105. The fixing device fixes the unfixed toner image on the paper sheet 108 as the paper sheet 108 conveyed from the transferring portion is pressed and heated in the pressure contact portion of the fixing roller 105 and the pressure roller 106. The paper sheet 108 bearing a fixed image is discharged to the exterior of the image forming apparatus.

The image forming apparatus has a registration sensor 109 that senses registration marks of the respective colors Y, M, C, Bk formed on the intermediate transfer belt 103, thereby measuring the color misregistration amounts of the respective colors. The result of measurement is fed back to the optical scanning apparatus 11, whereby a high quality color image free from color misregistration can be formed.

The printer controller 101 performs not only the above-described data conversion but also controls of the various units in the image forming apparatus and a motor in the optical scanning apparatus etc, though not shown in FIG. 16.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-184755, filed Jul. 16, 2008, which is hereby incorporated by reference herein in its entirety.

1. An optical scanning apparatus comprising:
a plurality of light source units;
a deflection unit for deflectively scanning a plurality of light fluxes emitted from the plurality of light source units by a same deflection surface; and
a plurality of imaging optical systems respectively associated with the plurality of light fluxes deflectively scanned by the same deflection surface of the deflection unit, the plurality of light fluxes having been deflectively scanned by the same deflection surface of the deflection unit being respectively focused on different photosensitive drums by the plurality of imaging optical systems,
wherein in a sub-scanning section, each of the plurality of light fluxes incident on the same deflection surface of the deflection unit is incident on the deflection surface from an oblique direction,
each of the plurality of imaging optical system includes a mirror,
one imaging optical system among the plurality of imaging optical systems includes a transmission type imaging optical element provided in an optical path between the mirror and the photosensitive drum, and
in the sub-scanning section, at least one of a surface vertex or virtual surface vertex of an incidence surface of the transmission type imaging optical element and a surface vertex or virtual surface vertex of an emergence surface of the transmission type imaging optical element is decentered from a center CL of an outer shape of the transmission type imaging optical element to a side same as an optical path on which a light flux Ra having been deflected by the deflection surface and traveling toward a mirror in another imaging optical system among the plurality of imaging optical systems.

2. An optical scanning apparatus according to claim 1, wherein in the sub-scanning section, a principal ray Rbo of a light flux Rb passing through the transmission type imaging optical element passes through a side opposite to the optical path on which the light flux having been deflected by the deflection surface and traveling toward the mirror of the other imaging optical system among the plurality of imaging optical systems, with respect to a straight line PL connecting the surface vertex or virtual surface vertex of the incidence surface of the transmission type imaging optical element and the surface vertex or virtual surface vertex of the emergence surface of the transmission type imaging optical element.

3. An optical scanning apparatus comprising:
a light source unit;
a deflection unit for deflectively scanning a light flux emitted from the light source unit by a deflection surface; and
an imaging optical system that focuses the light flux having been deflectively scanned by the deflection surface of the deflection unit on a photosensitive drum,
wherein in a sub-scanning section, the light flux incident on the deflection surface of the deflection unit is incident on the deflection surface from an oblique direction,
the imaging optical system includes a mirror,
a transmission type imaging optical element provided in an optical path between the mirror and the photosensitive drum, and
in the sub-scanning section, at least one of a surface vertex or virtual surface vertex of an incidence surface of the transmission type imaging optical element and a surface vertex or virtual surface vertex of an emergence surface of the transmission type imaging optical element is decentered from a center of an outer shape of the transmission type imaging optical element to a side same as an optical path on which a light flux having been deflected by the deflection surface and traveling toward the mirror.

4. An optical scanning apparatus according to claim 3, wherein in the sub-scanning section, a principal ray of a light flux Rb1 passing through the transmission type imaging optical element passes through a side opposite to the optical path on which the light flux having been deflected by the deflection surface and traveling toward the mirror, with respect to a straight line connecting the surface vertex or virtual surface vertex of the incidence surface of the transmission type imaging optical element and the surface vertex or virtual surface vertex of the emergence surface of the transmission type imaging optical element.

5. An optical scanning apparatus comprising:
a light source unit;
a deflection unit for deflectively scanning a light flux emitted from the light source unit by a deflection surface; and
an imaging optical system that focuses the light flux having been deflectively scanned by the deflection surface of the deflection unit on a photosensitive drum,
wherein in a sub-scanning section, the light flux incident on the deflection surface of the deflection unit is incident on the deflection surface from an oblique direction,
the imaging optical system includes mirror,
a transmission type imaging optical element provided in an optical path between the mirror and the photosensitive drum, and
in the sub-scanning section, the transmission type imaging optical element lacks an element portion on a side opposite to a side on which a light flux having been deflected by the mirror is incident, with respect to a straight line connecting a surface vertex or a virtual surface vertex of an incidence surface of the transmission type imaging optical element and a surface vertex or a virtual surface vertex of an emergence surface of the transmission type imaging optical system under the hypothetical assumption that the transmission type imaging optical element had a symmetrical shape, and has an asymmetrical shape with respect to a center of an outer shape of the transmission type imaging optical system.

6. An image forming apparatus comprising:
the optical scanning apparatus according to claim 1;
a plurality of photosensitive members;
a plurality of developing devices that are provided in association with the plurality of photosensitive members and develop electrostatic latent images formed on the respective photosensitive members by the light fluxes scanned by the optical scanning apparatus into toner images;
a plurality of transferring devices that are provided in association with the plurality of photo sensitive members and transfer the developed toner images onto a transferred material; and
a plurality of fixing devices that are provided in association with the plurality of photosensitive members and fix the transferred toner images on the transferred material.

7. An image forming apparatus comprising:
the optical scanning apparatus according to claim 3;
a photosensitive member;
a developing device that develops an electrostatic latent image formed on the photosensitive member by the light flux scanned by the optical scanning apparatus into a toner image;
a transferring device that transfers the developed toner image onto a transferred material; and
a fixing device that fixes the transferred toner image on the transferred material.

8. An image forming apparatus comprising:
the optical scanning apparatus according to claim 5;
a photosensitive member;
a developing device that develops an electrostatic latent image formed on the photosensitive member by the light flux scanned by the optical scanning apparatus into a toner image;
a transferring device that transfers the developed toner image onto a transferred material; and
a fixing device that fixes the transferred toner image on the transferred material.
